(19) United States
(12) Patent Application Publication
(10) Pub. No.: US 2022/0379818 A1
(43) Pub. Date: Dec. 1, 2022

(54) STORAGE APPARATUS FOR A VEHICLE

(71) Applicant: Terry Baillie, Wellesley, MA (US)

(72) Inventor: Terry Baillie, Wellesley, MA (US)

(21) Appl. No.: 17/589,974

(22) Filed: Feb. 1, 2022

Related U.S. Application Data
(60) Provisional application No. 63/193,179, filed on May 26, 2021.

(51) Int. Cl. B60R 11/00; B65D 5/02; B65D 43/02; B65D 55/16

(52) U.S. Cl. CPC B60R 11/00; B65D 5/029; B65D 5/0227; B65D 43/0222; B65D 55/16; B60R 2011/0071; B60R 2011/0052; B60R 2011/0036

(57) ABSTRACT

Apparatus is provided for a storage system that can be securely and reversibly installed in a vehicle. The apparatus presented comprises a storage unit which may readily store multiple small-to-medium objects, and which may be securely fastened to the vehicle frame or vehicle elements. The apparatus further presents aspects allowing easy access to the storage unit, for loading and unloading, and allowing the storage unit to be securely fastened closed for storage. The storage apparatus' storage unit may comprise a single sheet of material, folded and joined to create adjacent sides. The present invention solves problems with the currently available apparatuses of vehicle storage systems.

### FIELD OF THE INVENTION

The presently disclosed subject matter relates to providing apparatus for storage for a vehicle, and more particularly, to apparatus for a storage system that can be securely and reversibly installed in a vehicle.

### BACKGROUND OF THE INVENTION

In vehicles, there is often a need for storage for small-to-medium sized objects. Customizing storage boxes to fit a range of makes and models of vehicles has typically been a costly manufacturing problem. Providing a storage apparatus for a vehicle that is compact, offers maximized storage space for its volume in the vehicle, and can be easily installed securely in and easily removed from the vehicle, has been a challenge for vehicle manufacturers and accessory manufacturers.

In addition, there is a need for a storage apparatus for a vehicle that can be easily opened for access to its interior, and easily and securely closed for storage.

The prior art does not meet the needs for such a storage apparatus for a vehicle.

### SUMMARY OF THE INVENTION

The present invention meets all these needs, by disclosing a storage apparatus for a vehicle, that can be easily installed and removed from a vehicle, that fits securely in a vehicle, that may be affixed to the vehicle frame, that can be easily accessed to load items into and unload items from the storage apparatus, that can be cost-effectively manufactured, stocked, and shipped, and that can be secured to prevent items from becoming loose and creating a nuisance or hazard in the vehicle.

The present invention addresses the problems of the prior art, which do not present a storage apparatus for a vehicle that meets all of these needs.

In one aspect, the present disclosure comprises a storage unit, which further comprises a plurality of surfaces, including but not limited to a front wall; a distal side wall; a proximal side wall; a proximal side extension; a rear wall; and a bottom wall; wherein the storage unit comprises a plurality of storage unit material, a lid, a plurality of wall fasteners, a plurality of lid fasteners, and a plurality of vehicular fastener components.

In one aspect, the present disclosure further comprises the proximal side extension is affixed to the proximal side wall.

In one aspect, the present disclosure further comprises a proximal side formation portion which is folded onto or with the proximal side wall, from any extent or side or edge of the proximal side wall, and is thereupon affixed with the portion of such piece of material as forms the proximal side wall, to form the proximal side extension, and whereupon the proximal side extension is folded out from the proximal side wall and the proximal side formation portion.

In one aspect, the present disclosure further comprises the plurality of wall fasteners are disposed in any wall or side of the storage unit to secure another wall or side of the storage unit.

In one aspect, the present disclosure further comprises the plurality of lid fasteners are disposed in any wall or side of the storage unit to secure the lid.

In one aspect, the present disclosure further comprises the plurality of lid fasteners further comprise a plurality of lid-fastener-retainers, and wherein the plurality of lid-fastener-retainers are positioned in an interior of the storage unit, and wherein each of the plurality of lid-fastener-retainers are affixed to each of the plurality of lid fasteners.

In one aspect, the present disclosure further comprises one or more of the front wall, the distal side wall, and/or the rear wall comprises a plurality of wall anchors, to which the plurality of wall fasteners can be reversibly affixed or removed; and wherein the plurality of lid fasteners can be reversibly affixed to or removed from any of the plurality of wall anchors.

In one aspect, the present disclosure further comprises the plurality of wall fasteners further comprises a plurality of wall-fastener-retainers, and wherein each of the plurality of wall-fastener-retainers is affixed to each of the plurality of wall fasteners, such that each of the plurality of wall-fastener-retainers may retain the plurality of wall fasteners at a wall or side of the storage unit, from where it may be used to secure another wall or side of the storage unit.

In one aspect, the present disclosure further comprises the plurality of vehicular fastener components may comprise a strap and/or a plurality of fastener attachment points.

In one aspect, the present disclosure further comprises one or more of the front wall, the distal side wall, and/or the rear wall comprise a plurality of hinge-regions.

In one aspect, the present disclosure further comprises any of the plurality of hinge-regions comprises a flexible region of the respective wall in which said hinge-region is located, the flexible region comprising storage unit material that is pinched, weakened, thinned, perforated, creased, or otherwise made easier to fold.

In one aspect, the present disclosure further comprises one or more of the front wall, the distal side wall, the proximal side wall, the rear wall, the bottom wall, and/or the lid, collectively the sidings, may comprise a plurality of panels.

In one aspect, the present disclosure further comprises the storage unit comprises a single sheet of storage unit material, which is folded and joined to itself with joining means, such that the front wall, distal side wall, proximal side wall, proximal side extension, rear wall, and bottom wall are formed from the single sheet of storage unit material.

In one aspect, the present disclosure further comprises the storage unit may be folded in either orientation to make either a storage unit for a left side of a vehicle, or a storage unit for a right side of a vehicle.

In one aspect, the present disclosure further comprises the lid is formed from a sheet of lid material, which lid material comprises: a lid main extent, wherein the lid main extent comprises a plurality of lid-end-folding-slots; a plurality of lid-sides, each of the plurality of lid-sides comprising a plurality of lid-side-tabs; a plurality of lid-ends, each of the plurality of lid-ends comprising a plurality of lid-end-fold-portions, and a plurality of lid-end-tabs; a plurality of lid-end-hinge-regions; and a plurality of lid-side-hinge-regions.

In one aspect, the present disclosure further comprises to form the lid, the lid material is folded such that the plurality of lid-ends and the plurality of lid-end-fold-portions are folded to form a volume of space between the plurality of lid-ends and the plurality of lid-end-fold-portions, and the plurality of lid-sides are folded to form the plurality of sides of the lid, with the plurality of lid-side-tabs folded inward, and into the volume of space between the plurality of lid-ends and the plurality of lid-end-fold-portions; and wherein the plurality of lid-ends and the plurality of lid-end-fold-portions are folded at the plurality of lid-end-hinge-regions; and wherein the plurality of lid-sides may be folded at the plurality of lid-side-hinge-regions, and the plurality of lid-side-tabs may be folded inward at the plurality of lid-side-hinge-regions.

In one aspect, the present disclosure comprises an apparatus for storage container for a vehicle interior, the apparatus comprising: storage unit, which further comprises a plurality of surfaces, including but not limited to a distal side wall which comprises a plurality of hinge-regions; a proximal side wall; and a bottom wall; and plurality of vehicular fastener components.

In one aspect, the present disclosure further comprises any of the plurality of hinge-regions comprises a flexible region of the distal side wall, the flexible region being made easier to fold.

In one aspect, the present disclosure comprises an apparatus for storage container for a vehicle interior, the apparatus comprising: a storage unit, which comprises a single sheet of storage unit material, and wherein the single sheet of storage unit material is folded and joined to itself with joining means, forming the storage unit, and a plurality of vehicular fastener components.

In one aspect, the present disclosure further comprises the single sheet of storage unit material is folded and joined to itself to form a front wall, a distal side wall, a proximal side wall, a proximal side extension, a proximal side formation portion, a rear wall, and a bottom wall, which comprise the storage unit.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 shows a side and top perspective view of an aspect of the apparatus of the present invention.

FIG. 2 shows a top plan view of an aspect of the apparatus of the present invention.

FIG. 3 shows a front and top perspective view of an aspect of the apparatus of the present invention.

FIG. 4 shows a rear elevation view of an aspect of the apparatus of the present invention.

FIG. 5 shows a bottom plan view of an aspect of the apparatus of the present invention.

FIG. 6 shows a top and side perspective view of an aspect of the apparatus of the present invention.

FIG. 7 shows a side and rear perspective view of an aspect of the apparatus of the present invention.

FIG. 8 shows a side and bottom perspective view of an aspect of the apparatus of the present invention.

FIG. 9 shows a top plan view of an aspect of the apparatus of the present invention, showing an unfolded sheet of material in one orientation.

FIG. 10 shows a top plan view of an aspect of the apparatus of the present invention, showing an unfolded sheet of material in an orientation opposite to the orientation shown in FIG. 9.

FIG. 11 shows a top plan view of an aspect of the apparatus of the present invention, showing an unfolded sheet of material for a lid of the apparatus.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described. The word “approximately” as used herein means within 10% of a stated value, and for ranges as given, applies to both the start and end of the range of values given.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use the present invention.

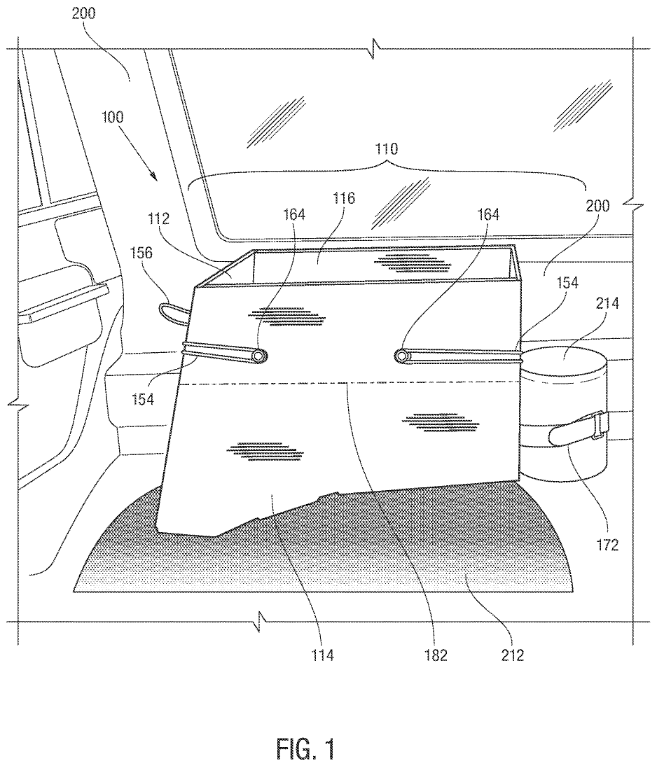

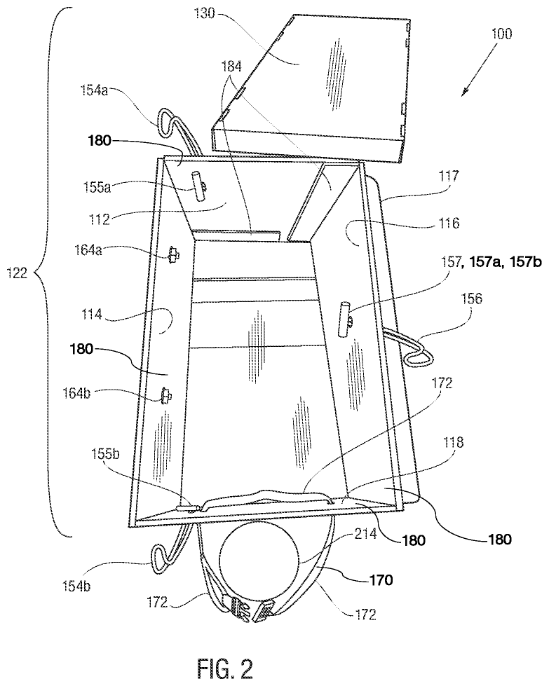

With reference to FIG. 1 and FIG. 2, the present invention comprises an apparatus 100 for storage container for a vehicle interior, to be placed in and used in a vehicle. The apparatus 100 may advantageously comprise one or more panels of material, which may be fastened or affixed to each other to form the container. At a high level of description, in some aspects of the present disclosure, the apparatus 100: comprises sizes and shapes which may disposed to fit on or over vehicle components, including but not limited to interior wheel wells; comprises components disposed to have the apparatus 100 reversibly affixed to a plurality of elements of the vehicle, which components may be reversibly affixed to the vehicle using any of a plurality of fastener elements; comprises hinges or foldable components to allow portions of the apparatus 100 to fold or hinge; comprises a lid which may be reversibly affixed to or removed from, or hinged to, the remainder of the apparatus 100; comprises internal dividers; and/or comprises unit fasteners to secure the apparatus 100 in a closed state and reversibly allow the various components of the apparatus 100 to be opened to an open state for access and closed to a closed state for storage.

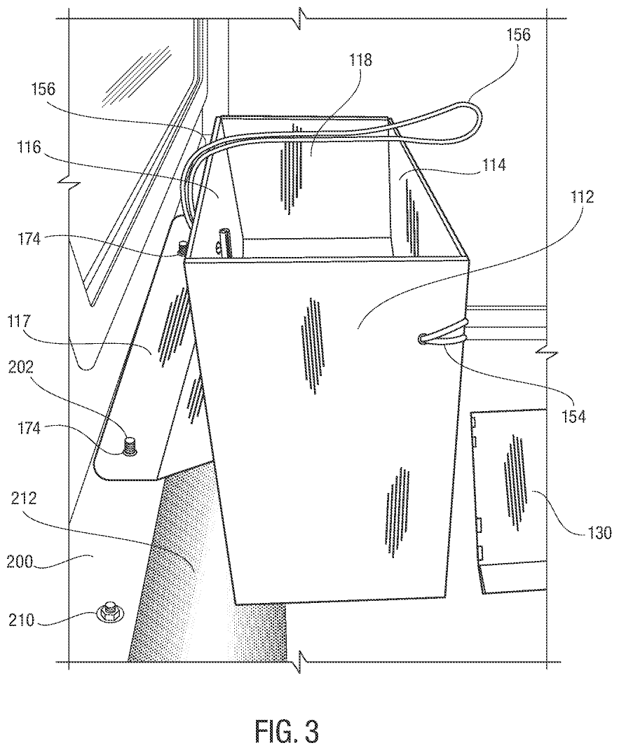

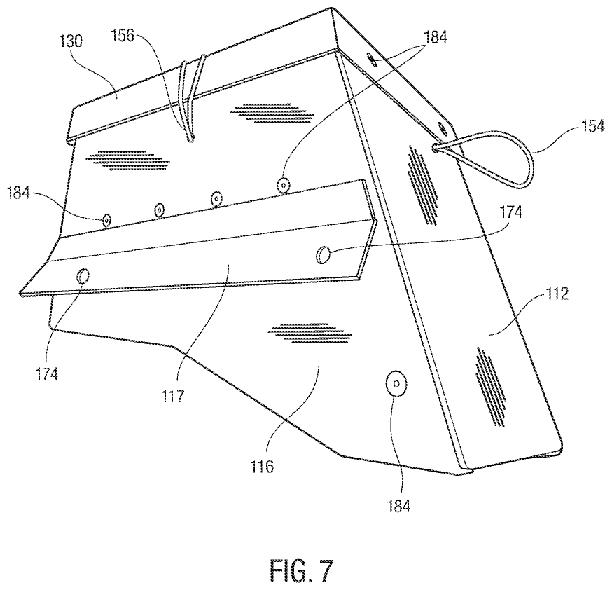

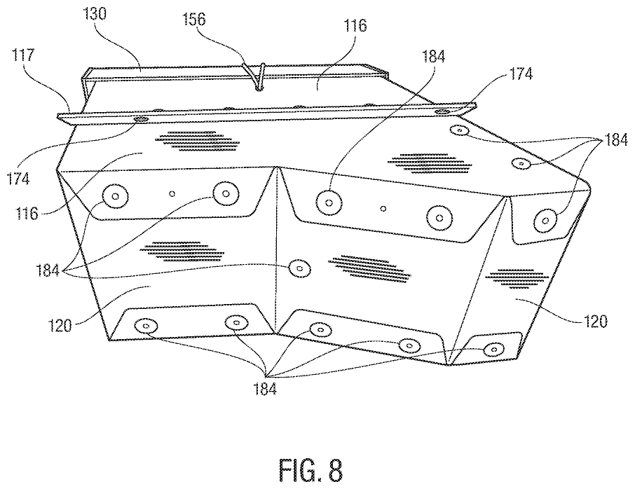

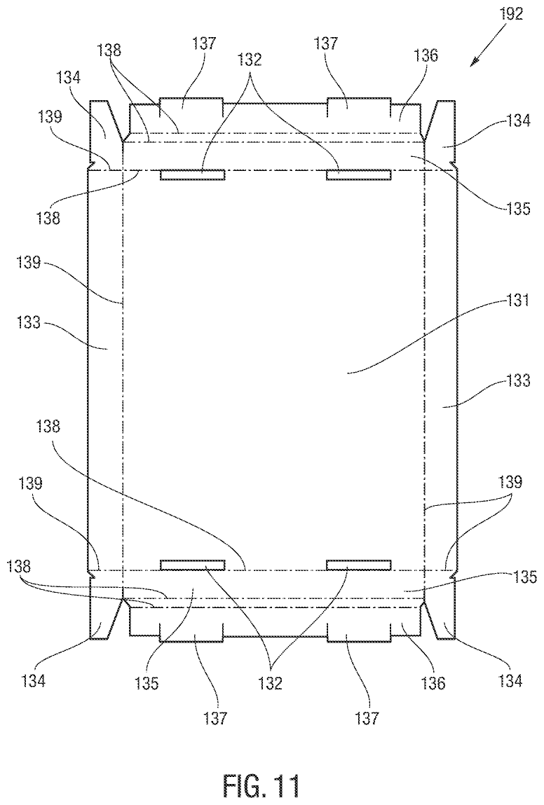

With reference to FIG. 1, FIG. 2, FIG. 3, FIG. 7, FIG. 8, and FIG. 11, the apparatus 100 comprises a storage unit 110, a lid 130, a plurality of wall fasteners 154, a plurality of lid fasteners 156, and a plurality of vehicular fastener components 170. The apparatus 100 may, in some aspects, not comprise a lid 130. The apparatus 100 is disposed to be placed in a vehicle 200, and to fit on, over, next to, or adjacent to any of a range of vehicle elements 210, and advantageously, the apparatus 100 is disposed to fit snugly with the vehicle elements 210 which the apparatus 100 is to be placed adjacent to. The vehicle elements 210 may comprise a list of elements commonly found in vehicles, including but not limited to a plurality of wheel wells 212, a plurality of vehicle posts 214 including but not limited to rollbars or support pillars or vehicle chassis components, or a plurality of vehicle cap fastener components, a plurality of bed frames, a plurality of trunk bolts, a plurality of seat belts, and/or a plurality of seat belt buckles, and/or arm rests. The apparatus 100 may be made for a particular side of a vehicle 200, or may be made to fit either side of a vehicle 200. The apparatus 100 may be symmetrical or asymmetrical.

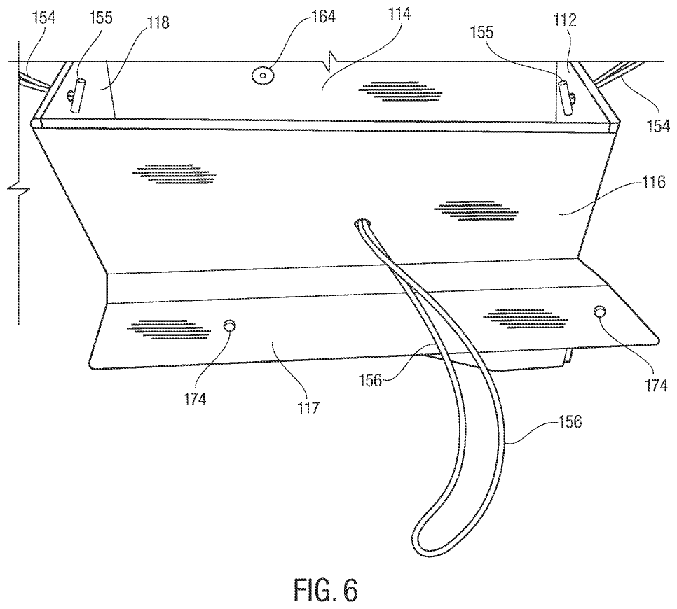

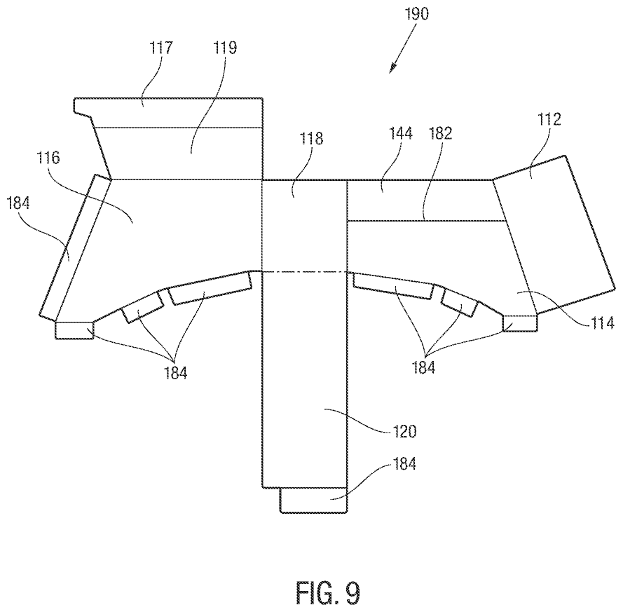

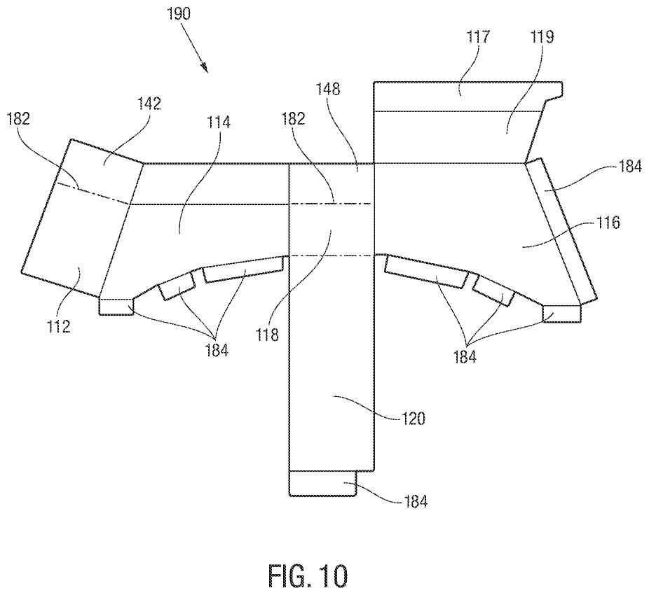

With reference to FIG. 1, FIG. 2, FIG. 3, FIG. 6, FIG. 7, FIG. 8, FIG. 9, and FIG. 10, the storage unit 110 further comprises a plurality of surfaces, including but not limited to a front wall 112; a distal side wall 114 which is distal from the vehicle 200, advantageously oriented toward the interior of the vehicle 200; a proximal side wall 116 which is proximal to the vehicle 200 and approximately opposite the distal side wall 114; a rear wall 118, which rear wall 118 is approximately opposite the front wall 112; and a bottom wall 120, advantageously oriented toward a surface of the vehicle 200, whereby the vehicle 200 contacts the bottom wall 120, providing load-bearing support to the apparatus 100. The proximal side wall 116 may further comprise a proximal side extension 117. In some aspects of the present disclosure, the proximal side extension 117 may be a separate component that is affixed to the proximal side wall 116. In some aspects of the present disclosure, the proximal side extension 117 may be a continuous piece of the proximal side wall 116 that is folded with or folded from the proximal side wall 116. In such aspects of the present disclosure, the proximal side extension 117 is part of the same sheet of storage unit material 190 or portion of a sheet of storage unit material 190, described below in greater detail, that comprises the proximal side wall 116, and the proximal side extension 117 is folded onto or with the proximal side wall 116, from any extent or side or edge of the proximal side wall 116, and is thereupon affixed with the portion of such piece of material as forms the proximal side wall 116. In some aspects of the present disclosure, the sheet of storage unit material 190 may comprise a proximal side formation portion 119, wherein the proximal side formation portion 119 is folded onto or with the proximal side wall 116, from any extent or side or edge of the proximal side wall 116, and is thereupon affixed with the portion of such piece of material as forms the proximal side wall 116, and whereupon the proximal side extension 117 is folded out from the proximal side wall 116 and the proximal side formation portion 119. Advantageously, the proximal side extension 117 is thereby affixed to the proximal side wall 116 and also protrudes from the proximal side wall 116.

With reference to FIG. 1, FIG. 2, FIG. 3, FIG. 6, FIG. 7, and FIG. 8, the plurality of wall fasteners 154 allow the apparatus 100 to be reversibly and securely fastened in a closed state, or opened to be in an opened state. When the apparatus 100 is in an open state, items may be placed into the apparatus 100 for storage, or removed from the apparatus 100. When the apparatus 100 is in a closed state, secured with the wall fasteners 154, the apparatus 100 should remain securely shut, so that any contents of the apparatus 100 remain in the apparatus 100. The plurality of wall fasteners 154 may be disposed in any wall or side of the storage unit 110 to secure another wall or side of the storage unit 110. The plurality of lid fasteners 156 may be disposed in any wall or side of the storage unit 110 to secure the lid 130. Any of the wall fasteners 154 may be disposed on one or more of the surfaces of the storage unit 110, such that they may reach to and fasten a different one of the surfaces of the storage unit 110 than the surface on which that one of the wall fasteners 154 is disposed. The plurality of wall fasteners 154 may be disposed on the front wall 112 and/or on the rear wall 118. The plurality of wall fasteners 154 may be disposed on the distal side wall 114 and/or on the proximal side wall 116. The plurality of wall fasteners 154 may be disposed on the front wall 112 and/or on the rear wall 118. The plurality of lid fasteners 156 may be disposed on one or more of the front wall 112, the distal side wall 114, the proximal side wall 116, and/or the rear wall 118. As will be apparent to one of skill in the art, any of the foregoing surfaces may advantageously be opened or closed in a given aspect of the present disclosure, and the relevant plurality of fasteners will serve to have the surface reversibly secured such that the surface may be opened or closed. The plurality of lid fasteners 156 may further comprise a plurality of lid-fastener-retainers 157. The plurality of lid-fastener-retainers 157 may advantageously be positioned in an interior of the storage unit 110, the interior of the storage unit 110 being defined by the sides, walls, top, and/or bottom of the storage unit 110. Advantageously, each of the plurality of lid-fastener-retainers 157 may be affixed to each of the plurality of lid fasteners 156, separately from a portion of the lid fasteners 156 that comprises the lid-fastener-retainers 157, such that each of the plurality of lid-fastener-retainers 157 may retain the plurality of lid fasteners 156 at a wall or side of the storage unit 110, from where it may be used to secure the lid 130. Though not depicted in FIG. 2, in aspects of the present disclosure wherein the plurality of lid-fastener-retainers 157 number more than one, each of the plurality of lid-fastener-retainers 157 may be referred to as a first lid-fastener-retainer 157a, a second lid-fastener-retainer 157b, and so on for any number n of lid-fastener-retainers 157.

With reference to FIG. 1, FIG. 2, FIG. 3, FIG. 7, and FIG. 8, the front wall 112 may comprise a plurality of wall anchors 164, to which the plurality of wall fasteners 154 may be reversibly affixed or removed. The distal side wall 114 may comprise a plurality of wall anchors 164, to which the plurality of wall fasteners 154 may be reversibly affixed or removed. The rear wall 118 may comprise a plurality of wall anchors 164, to which the plurality of wall fasteners 154 may be reversibly affixed or removed. The lid fasteners 156 may be reversibly affixed to or removed from any of the plurality of wall anchors 164, which may be comprised as part of, or attached to, one or more of the front wall 112, the distal side wall 114, the proximal side wall 116, and/or the rear wall 118. Each of the plurality of wall anchors 164 may be referred to as a first wall anchor 164a, a second wall anchor 164b, and so on for any number n of wall anchors 164.

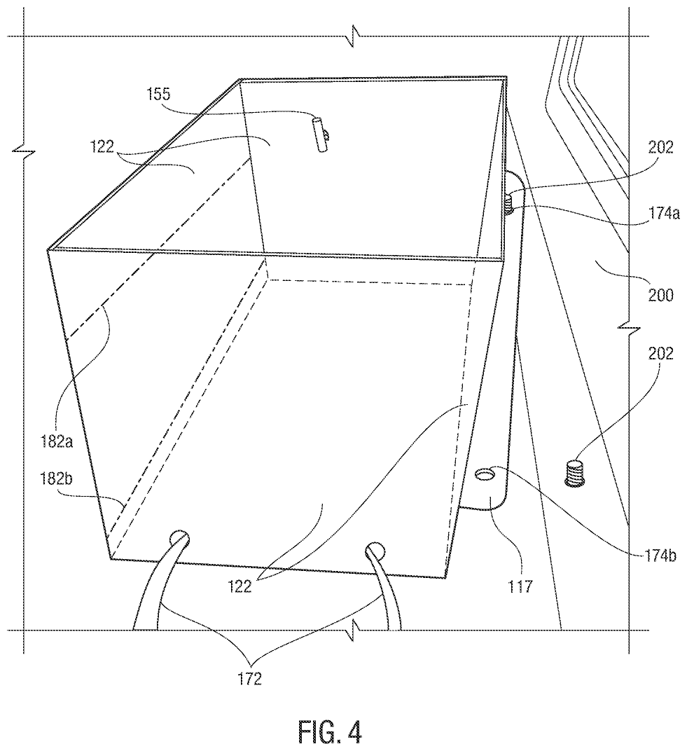

With reference to FIG. 1, FIG. 2, FIG. 3, FIG. 4, FIG. 6, and FIG. 7, in certain aspects of the present disclosure, each of the plurality of wall fasteners 154 may be referred to as a first wall fastener 154a, a second wall fastener 154b, and so on for any number n of wall fasteners 154. The plurality of wall fasteners 154 may further comprise a plurality of wall-fastener-retainers 155. The plurality of wall-fastener-retainers 155 may advantageously be positioned in the interior of the storage unit 110. Advantageously, each of the plurality of wall-fastener-retainers 155 may be affixed to each of the plurality of wall fasteners 154, separately from a portion of the wall fasteners 154 that comprises the wall-fastener-retainers 155, such that each of the plurality of wall-fastener-retainers 155 may retain the plurality of wall fasteners 154 at a wall or side of the storage unit 110, from where it may be used to secure another wall or side of the storage unit 110. Each of the plurality of wall-fastener-retainers 155 may be referred to as a first wall-fastener-retainer 155a, a second wall-fastener-retainer 155b, and so on for any number n of wall-fastener-retainers 155.

With reference to FIGS. 1-8, the plurality of vehicular fastener components 170 may comprise a strap 172; and/or the plurality of vehicular fastener components 170 may comprise a plurality of fastener attachment points 174, which fastener attachment points 174 may be disposed in the proximal side extension 117 or in other portion of the storage unit 110; and/or the plurality of vehicular fastener components 170 may comprise may comprise another arrangement of fasteners which, as will be apparent to one of skill in the art, may be used to affix the storage unit 110 to the vehicle 200. The strap 172 may reversibly affix the storage unit 110 to the vehicle 200, by wrapping around and reversibly fastening to a suitable support or portion of the vehicle 200. The plurality of fastener attachment points 174 may have bolts, clamps, or other type of fastener, as will be apparent to one of skill in the art, passed through the plurality of fastener attachment points 174, or the plurality of fastener attachment points 174 may be reversibly affixed to or have passed through them a vehicle component 202, where the vehicle component 202 comprises a component of the vehicle 200 and/or comprises a fastener that may be reversibly installed in and/or removed from the vehicle 200. In some aspects of the present disclosure, the proximal side extension 117 and/or the fastener attachment points 174 may be sized and disposed to match a particular make and model of a vehicle 200. As will be apparent to one of skill in the art, a variety of sizes and shapes of the apparatus 100 of the present disclosure may be made, such that the variety of apparatus 100 will fit a vehicle 200 belonging to a group of many varied makes and models of vehicles. Each of the plurality of fastener attachment points 174 may be referred to as a first fastener attachment point 174a, a second fastener attachment point 174b, and so on for any number n of fastener attachment points 174.

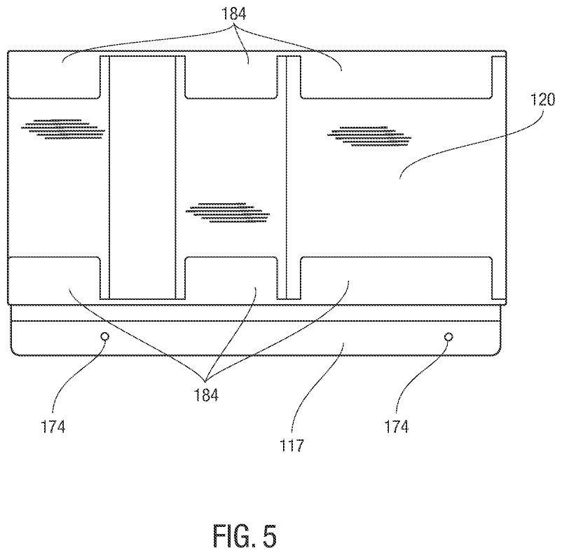

With reference to FIG. 1, FIG. 2, FIG. 4, FIG. 5, FIG. 7, FIG. 8, FIG. 9, and FIG. 10, in some aspects of the present disclosure, one or more of the front wall 112, the distal side wall 114, and/or the rear wall 118 may comprise a plurality of hinge-regions 182. Each of the hinge-regions 182 may comprise a flexible region of the respective wall (front wall 112, distal side wall 114, or rear wall 118), and/or a piano hinge, or door hinge, or strap hinge, or other mechanism now known or later invented which will serve to allow the respective wall (front wall 112, distal side wall 114, or rear wall 118) to bend and return. Alternatively, each or any of the hinge-regions 182 may comprise storage unit material 190 that may be pinched, weakened, thinned, perforated, creased, or otherwise made easier to fold. In some aspects of the present disclosure, any of the respective wall (front wall 112, distal side wall 114, or rear wall 118) may comprise more than one of the plurality of hinge-regions 182; in such aspects of the present disclosure, each of the plurality of hinge-regions 182 may be referred to as a first hinge-region 182a, a second hinge-region 182b, and so on for any number n of hinge-regions 182. In aspects of the present disclosure wherein one or more of the front wall 112, the distal side wall 114, and/or the rear wall 118 comprise a plurality of hinge-regions 182, the portion of the respective wall that may fold or hinge, relative to the remainder of the storage unit 110, is a front-wall-folding-portion 142 for the front wall 112, and is a distal-side-wall-folding-portion 144 for the distal side wall 114, and is a rear-wall-folding-portion 148 for the rear wall 118.

With reference to FIGS. 1-11, one or more of the front wall 112, the distal side wall 114, the proximal side wall 116, the rear wall 118, the bottom wall 120, and/or the lid 130, collectively the sidings 122, may comprise a plurality of panels 180, wherein the plurality of panels 180 may comprise corrugated plastic, metal, wood, solid plastic, or other material. In some aspects of the present disclosure, any or all of the sidings 122 may comprise one or more of the plurality of panels 180 that is folded and affixed to itself, or one of the sidings 122 may comprise more than one of the plurality of panels 180 wherein the more than one of the plurality of panels 180 are affixed to each other. In some aspects of the present disclosure, any or all of the sidings 122 may comprise a single one of the plurality of panels 180 that is folded and affixed to itself. Where a single one of the plurality of panels 180 is affixed to itself, or where multiple of the plurality of panels 180 are affixed to each other, the plurality of panels 180 may be affixed with heat welding, electrostatic welding, other forms of welding now known or later invented, mechanical fasteners including but not limited to rivets or bolts, adhesives, or other suitable means. The locations or places where the plurality of panels 180 are affixed to each other are referred to herein as a plurality of joinery regions 184.

With reference to FIGS. 1-11, in some aspects of the present disclosure, the components of the apparatus 100 disclosed above may be formed from a small number of sheets of storage unit material 190, each such sheet of storage unit material 190 being one of a plurality of sheets of storage unit material 190. The plurality of sheets of material may comprise one sheet of storage unit material 190, or two sheets of storage unit material 190, or three sheets of storage unit material 190, or four sheets of storage unit material 190, or five sheets of storage unit material 190, or six sheets of storage unit material 190, or seven sheets of storage unit material 190, or eight sheets of storage unit material 190, or nine sheets of storage unit material 190, or ten sheets of storage unit material 190, or another number of sheets of storage unit material 190. Namely, the storage unit 110 may comprise a single sheet of storage unit material 190, which is folded and joined to itself with joining means, as disclosed above, such that the front wall 112, distal side wall 114, proximal side wall 116, proximal side extension 117, rear wall 118, and bottom wall 120 are formed from one sheet of storage unit material 190 that is folded and joined to itself to form the disclosed components. In such aspects of the present disclosure, the single sheet of storage unit material 190 may be pinched, weakened, thinned, perforated, creased, or otherwise made easier to fold, to form the disclosed components. The storage unit 110 may be folded in either orientation, i.e., with either side of the sheet of storage unit material 190 up, to make either a storage unit 110 for the left side of the vehicle 200, or a storage unit 110 for the right side of the vehicle 200. With either fold and orientation of the sheet of storage unit material 190 and the storage unit 110, the lid 130 may be standard, such that the lid 130 will fit either a storage unit 110 for the left side of the vehicle 200, or a storage unit 110 for the right side of the vehicle 200.

In another aspect of the present disclosure, the foregoing components may be formed from two sheets of storage unit material 190, each folded to comprise certain of the foregoing components, and then the components comprised of the two sheets of storage unit material 190 are joined with each other. The sheets of storage unit material 190 may all be the same type of material, or may be different types of material, now known or later invented. Where a sheet or sheets of storage unit material 190 are folded and joined, there are joinery regions 184 of the sheet or sheets of material, such that the folded sides of the storage unit 110 may be joined together, with the joinery regions 184 continuous with at least one of the sides of the storage unit 110, and each serving to join one of the sidings 122 with another of the sidings 122 of the storage unit 110. In such aspects of the present disclosure, the sheets of storage unit material 190 may be pinched, weakened, thinned, perforated, creased, or otherwise made easier to fold, to form the disclosed components.

With reference to FIG. 2, FIG. 3, FIG. 7, FIG. 8, and FIG. 11, the lid 130 may be formed from a sheet of lid material 192. The lid material 192 may be the same type of material as the storage unit material 190, or may be a different type of material. The lid material 192 may comprise a lid main extent 131, wherein the lid main extent 131 comprises a plurality of lid-end-folding-slots 132, wherein the lid-end-folding-slots 132 may be holes or voids formed in or cut in the lid main extent 131. The lid material 192 may comprise a plurality of lid-sides 133 and a plurality of lid-ends 135. Each of the plurality of lid-sides 133 may further comprise a plurality of lid-side-tabs 134. Each of the plurality of lid-ends 135 may further comprise a plurality of lid-end-fold-portions 136, advantageously distal from the lid main extent 131, and the plurality of lid-ends 135 may further comprise a plurality of lid-end-tabs 137. To form the lid 130, the lid material 192 may be folded such that the plurality of lid-ends 135 and the plurality of lid-end-fold-portions 136 are folded to form a volume of space between the plurality of lid-ends 135 and the plurality of lid-end-fold-portions 136, and the plurality of lid-sides 133 are folded to form the plurality of sides of the lid 130, with the plurality of lid-side-tabs 134 folded inward, and into the volume of space between the plurality of lid-ends 135 and the plurality of lid-end-fold-portions 136. The plurality of lid-end-tabs 137 are advantageously disposed at the distal portion or edge of the lid-end-fold-portions 136, and advantageously disposed in size, shape, and position to, when the plurality of lid-ends 135 and the plurality of lid-end-fold-portions 136 are folded, fit into and engage securely and reversibly with the plurality of lid-end-folding-slots 132.

In aspects of the present disclosure wherein the plurality of lid-ends 135 and the plurality of lid-end-fold-portions 136 are folded, the lid material 192 may further comprise a plurality of lid-end-hinge-regions 138, wherein the lid material 192 may be pinched, weakened, thinned, perforated, creased, or otherwise made easier to fold. The plurality of lid-end-hinge-regions 138 may be discontinuous, with multiple of the plurality of lid-end-hinge-regions 138 which are not contiguous with each other, as shown in FIG. 11. The plurality of lid-ends 135 and the plurality of lid-end-fold-portions 136 may be folded at the plurality of lid-end-hinge-regions 138. The plurality of lid-ends 135 and the plurality of lid-end-fold-portions 136 may be affixed with heat welding, electrostatic welding, other forms of welding now known or later invented, mechanical fasteners including but not limited to rivets or bolts, adhesives, or other suitable means, or the plurality of lid-ends 135 and the plurality of lid-end-fold-portions 136 may be folded and maintained in place through elasticity of the lid material 192 and friction against the other components of the lid 130.

In aspects of the present disclosure wherein the plurality of lid-sides 133 are folded to form the plurality of sides of the lid 130, the lid material 192 may further comprise a plurality of lid-side-hinge-regions 139, wherein the lid material 192 may be pinched, weakened, thinned, perforated, creased, or otherwise made easier to fold. The plurality of lid-side-hinge-regions 139 may be discontinuous, with multiple of the plurality of lid-side-hinge-regions 139 which are not contiguous with each other, as shown in FIG. 11. The plurality of lid-sides 133 may be folded at the plurality of lid-side-hinge-regions 139. The plurality of lid-side-tabs 134 may be folded inward at the plurality of lid-side-hinge-regions 139. The plurality of lid-sides 133 and the plurality of lid-side-tabs 134 may be affixed with heat welding, electrostatic welding, other forms of welding now known or later invented, mechanical fasteners including but not limited to rivets or bolts, adhesives, or other suitable means, or the plurality of lid-ends 135 and the plurality of lid-end-fold-portions 136 may be folded and maintained in place through elasticity of the lid material 192 and friction against the other components of the lid 130.

Certain aspects of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. An apparatus for storage container for a vehicle interior, the apparatus comprising:
a storage unit, which further comprises a plurality of surfaces, including but not limited to a front wall; a distal side wall; a proximal side wall; a proximal side extension; a rear wall; and a bottom wall; wherein the storage unit comprises a plurality of storage unit material,
a lid,
a plurality of wall fasteners,
a plurality of lid fasteners, and
a plurality of vehicular fastener components.

2. The apparatus of claim 1, wherein the proximal side extension is affixed to the proximal side wall.

3. The apparatus of claim 1, wherein the apparatus further comprises a proximal side formation portion which is folded onto or with the proximal side wall, from any extent or side or edge of the proximal side wall, and is thereupon affixed with a portion of such piece of material as forms the proximal side wall, to form the proximal side extension, and whereupon the proximal side extension is folded out from the proximal side wall and the proximal side formation portion.

4. The apparatus of claim 1, wherein the plurality of wall fasteners are disposed in any wall or side of the storage unit to secure another wall or side of the storage unit.

5. The apparatus of claim 1, wherein the plurality of lid fasteners are disposed in any wall or side of the storage unit to secure the lid.

6. The apparatus of claim 1, wherein the plurality of lid fasteners further comprise a plurality of lid-fastener-retainers, and wherein the plurality of lid-fastener-retainers are positioned in an interior of the storage unit, and wherein each of the plurality of lid-fastener-retainers are affixed to each of the plurality of lid fasteners.

7. The apparatus of claim 1, wherein one or more of the front wall, the distal side wall, and/or the rear wall comprises a plurality of wall anchors, to which the plurality of wall fasteners can be reversibly affixed or removed; and wherein the plurality of lid fasteners can be reversibly affixed to or removed from any of the plurality of wall anchors.

8. The apparatus of claim 1, wherein the plurality of wall fasteners further comprises a plurality of wall-fastener-retainers, and wherein each of the plurality of wall-fastener-retainers is affixed to each of the plurality of wall fasteners, such that each of the plurality of wall-fastener-retainers may retain the plurality of wall fasteners at a wall or side of the storage unit, from where it may be used to secure another wall or side of the storage unit.

9. The apparatus of claim 1, wherein the plurality of vehicular fastener components may comprise a strap and/or a plurality of fastener attachment points.

10. The apparatus of claim 1, wherein one or more of the front wall, the distal side wall, and/or the rear wall comprise a plurality of hinge-regions.

11. The apparatus of claim 10, wherein any of the plurality of hinge-regions comprises a flexible region of the respective wall in which said hinge-region is located, the flexible region comprising storage unit material that is pinched, weakened, thinned, perforated, creased, or otherwise made easier to fold.

12. The apparatus of claim 1, wherein one or more of the front wall, the distal side wall, the proximal side wall, the rear wall, the bottom wall, and/or the lid, collectively the sidings, may comprise a plurality of panels.

13. The apparatus of claim 1, wherein the storage unit comprises a single sheet of storage unit material, which is folded and joined to itself with joining means, such that the front wall, distal side wall, proximal side wall, proximal side extension, rear wall, and bottom wall are formed from the single sheet of storage unit material.

14. The apparatus of claim 13, wherein the storage unit may be folded in either orientation to make either a storage unit for a left side of a vehicle, or a storage unit for a right side of a vehicle.

15. The apparatus of claim 1, wherein the lid is formed from a sheet of lid material, wherein the sheet of lid material comprises: a lid main extent, wherein the lid main extent comprises a plurality of lid-end-folding-slots; a plurality of lid-sides, each of the plurality of lid-sides comprising a plurality of lid-side-tabs; a plurality of lid-ends, each of the plurality of lid-ends comprising a plurality of lid-end-fold-portions, and a plurality of lid-end-tabs; a plurality of lid-end-hinge-regions; and a plurality of lid-side-hinge-regions.

16. The apparatus of claim 15, wherein to form the lid, the lid material is folded such that the plurality of lid-ends and the plurality of lid-end-fold-portions are folded to form a volume of space between the plurality of lid-ends and the plurality of lid-end-fold-portions, and the plurality of lid-sides are folded to form the plurality of sides of the lid, with the plurality of lid-side-tabs folded inward, and into the volume of space between the plurality of lid-ends and the plurality of lid-end-fold-portions; and wherein the plurality of lid-ends and the plurality of lid-end-fold-portions are folded at the plurality of lid-end-hinge-regions; and wherein the plurality of lid-sides may be folded at the plurality of lid-side-hinge-regions, and the plurality of lid-side-tabs may be folded inward at the plurality of lid-side-hinge-regions.

17. An apparatus for storage container for a vehicle interior, the apparatus comprising:
a storage unit, which further comprises a plurality of surfaces, including but not limited to a distal side wall which comprises a plurality of hinge-regions; a proximal side wall; and a bottom wall; and
a plurality of vehicular fastener components.

18. The apparatus of claim 17, wherein any of the plurality of hinge-regions comprises a flexible region of the distal side wall, the flexible region being made easier to fold.

19. An apparatus for storage container for a vehicle interior, the apparatus comprising:
a storage unit, which comprises a single sheet of storage unit material, and wherein the single sheet of storage unit material is folded and joined to itself with joining means, forming the storage unit, and
a plurality of vehicular fastener components.

20. The apparatus of claim 19, wherein the single sheet of storage unit material is folded and joined to itself to form a front wall, a distal side wall, a proximal side wall, a proximal side extension, a proximal side formation portion, a rear wall, and a bottom wall, which comprise the storage unit.
